(19) United States
(12) Patent Application Publication
(10) Pub. No.: US 2025/0100540 A1
(43) Pub. Date: Mar. 27, 2025

(54) HYBRID VEHICLE AND CONTROL METHOD FOR HYBRID VEHICLE

(71) Applicant: ISUZU MOTORS LIMITED, Yokohama-shi (JP)

(72) Inventor: Hikaru ITOH, Fujisawa-shi (JP)

(21) Appl. No.: 18/818,939

(22) Filed: Aug. 29, 2024

(30) Foreign Application Priority Data
Sep. 21, 2023 (JP) 2023-155528

(51) Int. Cl. B60W 20/15; B60W 10/06; B60W 10/08

(52) U.S. Cl. CPC B60W 20/15; B60W 10/06; B60W 10/08; B60W 2510/0633; B60W 2710/0627; B60W 2710/0644; B60W 2710/083

(57) ABSTRACT

A hybrid vehicle of the present disclosure includes a first determination section that determines a surge state of the turbocharger based on a state of the engine, a second determination section that determines the surge state of the turbocharger based on a state of the turbocharger, and a control section that controls the engine and controls assisting the engine with the electric drive motor based on determination results of the first determination section and the second determination section.

### CROSS REFERENCE TO RELATED APPLICATIONS

This application is entitled to and claims the benefit of Japanese Patent Application No. 2023-155528, filed on Sep. 21, 2023, the disclosure of which including the specification, drawings and abstract is incorporated herein by reference in its entirety.

### TECHNICAL FIELD

The present disclosure relates to a hybrid vehicle and a control method for a hybrid vehicle (i.e., method for controlling a hybrid vehicle).

### BACKGROUND ART

Conventionally, as described in, for example, Patent Literature (hereinafter, referred to as PTL) 1, there has been a hybrid vehicle including an engine, a turbocharger, and an electric drive motor. PTL 1 describes a technology in which, while controlling an engine to avoid a surging phenomenon generated in a compressor of a turbocharger, the decrease in the drive force of the engine at this time is supplemented with the drive force of an electric drive motor. According to the technology of PTL 1, it is possible to achieve a hybrid vehicle capable of avoiding the surging phenomenon of a turbocharger while maintaining drivability.

### CITATION LIST

### Patent Literature

### PTL 1

Japanese Patent Application No. 2015-182725

### SUMMARY OF INVENTION

### Technical Problem

In a hybrid vehicle described in PTL 1, the occurrence of surging (hereinafter, may be referred to as surge) is predicted based on the engine rotation speed, shift-up of the transmission, and the vehicle speed, and the engine and the electric drive motor are controlled.

For this reason, when the hybrid vehicle described in PTL 1 is applied to a vehicle with a continuously variable transmission, there is a possibility that a surge cannot be predicted. Further, in the hybrid vehicle described in PTL 1, there is also a possibility that a surge may occur when the accelerator is rapidly released.

In addition, in the conventional configuration, it is considered that the amount of calculation increases in order to reliably prevent surges, thereby complicating the control.

The present disclosure has been made in view of the above points, and aims to provide a hybrid vehicle capable of preventing surge generation and maintaining drivability while suppressing an increase in the amount of calculation, as well as a control method for a hybrid vehicle.

### Solution to Problem

An aspect of a hybrid vehicle of the present disclosure is a hybrid vehicle including:
an engine;
a turbocharger connected to an intake/exhaust system of the engine;
an electric drive motor;
a first determination section that performs determination of a surge state of the turbocharger based on a state of the engine;
a second determination section that performs determination of the surge state of the turbocharger based on a state of the turbocharger; and
a control section that controls the engine and controls assisting the engine with the electric drive motor, based on determination results of the first determination section and the second determination section.

An aspect of a method for controlling a hybrid vehicle of the present disclosure is a method for controlling a hybrid vehicle that includes an engine, a turbocharger connected to an intake/exhaust system of the engine, and an electric drive motor, the method including:
first determining of determining a surge state of the turbocharger based on a state of the engine;
second determining of determining the surge state of the turbocharger based on a state of the turbocharger; and
controlling the engine and controlling assisting the engine with the electric drive motor, based on determination results of the first determining and the second determining.

### Advantageous Effects of Invention

The present disclosure can provide a hybrid vehicle and a control method for a hybrid vehicle both capable of preventing surging and maintaining drivability while suppressing an increase in the amount of calculation.

### BRIEF DESCRIPTION OF DRAWINGS

FIG. 1 is a schematic diagram illustrating a main configuration of a hybrid vehicle in an embodiment;

FIG. 2 is a flowchart for describing an operation in the embodiment;

FIG. 3 is a diagram for describing a determination process in a first determination section and illustrating a relationship between an engine rotation number, a fuel flow rate, and a state corresponding to the vicinity of the surge region;

FIG. 4 is a diagram for describing a determination process in the second determination section, and illustrating a relationship between a modified air flow rate, a pressure ratio between a compressor inlet pressure and a compressor outlet pressure, and a region corresponding to the vicinity of a surge region;

FIG. 5 is a diagram for describing a difference between a vehicle required torque and an actual engine torque; and

FIG. 6 illustrates an example of a motor rotation speed and an output torque of the electric drive motor.

### DESCRIPTION OF EMBODIMENTS

Hereinafter, an embodiment of the present invention will be described with reference to the drawings.

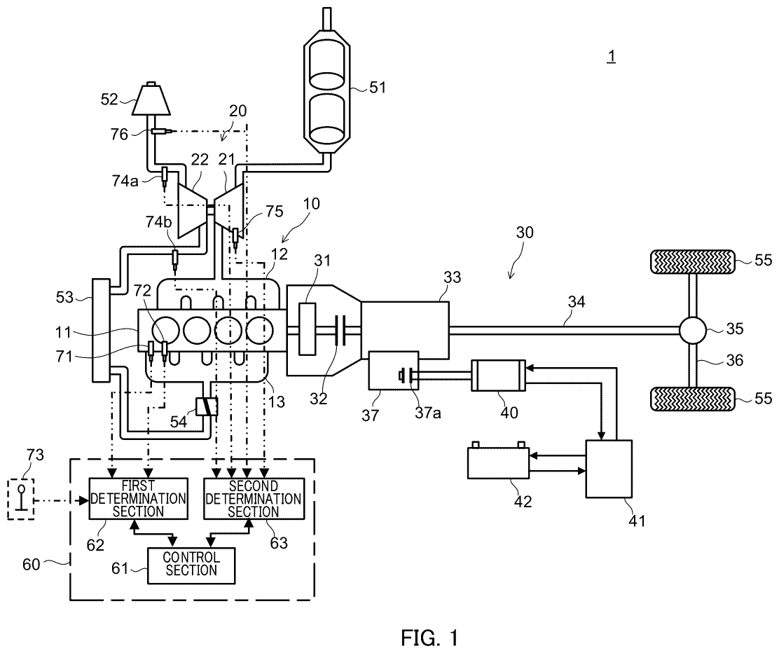

FIG. 1 is a schematic diagram illustrating the main configuration of hybrid vehicle 1 in the embodiment. Hybrid vehicle 1 includes an internal combustion engine (for example, a diesel engine or a gasoline engine, hereinafter, referred to as an engine) 10 turbocharger 20 connected to an intake/exhaust system of engine 10; power transmission mechanism 30 that transmits a drive torque generated by engine 10; electric drive motor 40 that is linked to power transmission mechanism 30; and battery 42 that is electrically connected to electric drive motor 40 via inverter 41.

Engine 10 includes engine main body 11, exhaust manifold 12, and intake manifold 13, among other components. Exhaust gas generated in engine main body 11 is sent to turbocharger 20 via exhaust manifold 12, drives turbine 21 of turbocharger 20, and is purified by exhaust gas processing apparatus 51 before being discharged.

Further, intake air sucked from air cleaner 52 is compressed and cooled by compressor 22 and intake cooler 53 of turbocharger 20, adjusted by intake throttle 54, and then supplied into engine main body 11 through intake manifold 13.

Power transmission mechanism 30 transmits the drive torque generated by engine 10 to transmission 33 via torque converter 31 and friction clutch (for example, a wet clutch including a viscous coupling) 32. Next, the drive torque is transmitted from transmission 33 to drive wheels 55 via propeller shaft 34, differential 35, and drive shaft 36. The configuration of the power transmission mechanism is not limited to the above described configuration. The power transmission mechanism may be, for example, a continuously variable transmission (CVT), a dual clutch transmission (DCT), or the like.

Further, the drive torque generated by electric drive motor 40 is transmitted to drive wheels 55 via slave dog clutch (hereinafter referred to as dog clutch) 37a of power take-off mechanism (PTO) 37. The present disclosure is not only applicable to only a type of hybrid vehicle in which the drive torque generated by electric drive motor 40 is transmitted to drive wheels 55 via PTO 37, but widely applicable to known hybrid vehicles that perform drive assist and regeneration using electric drive motor 40.

When electric drive motor 40 is driven in a regenerative manner, electric drive motor 40 acts as a generator and applies a braking force to power transmission mechanism 30 to generate regenerative power. When electric drive motor 40 is driven in power running mode, electric drive motor 40 acts as an electric motor to provide a drive force to power transmission mechanism 30, thereby providing assistance. The electrical power generated is converted by inverter 41 and charged into battery 42. Further, when electric drive motor 40 is electrically driven, the electrical power stored in battery 42 is converted by inverter 41 and supplied to electric drive motor 40.

Further, hybrid vehicle 1 includes control unit 60. Control unit 60 includes control section 61, first determination section 62, and second determination section 63. Each of control section 61, first determination section 62, and second determination section 63 includes, as main components, a central processing unit (CPU), a read only memory (ROM), a random access memory (RAM), and the like. The CPU reads programs corresponding to the processing content from the ROM, loads the programs in the RAM, and cooperates with the loaded programs to achieve the functions of respective control section 61, first determination section 62, and second determination section 63. All or part of control section 61, first determination section 62, and second determination section 63 may be formed from a hardwired circuit such as an application specific integrated circuit (ASIC) or a field-programmable gate array (FPGA).

An engine rotation speed from engine rotation sensor 71, a fuel flow rate from fuel sensor 72, and an accelerator opening degree from accelerator sensor 73 are input into first determination section 62. First determination section 52 determines a surge state of turbocharger 20 based on the engine rotation speed, the fuel flow rate, or the accelerator opening degree.

The “surge state” in the present specification is not limited to the state in which surge is occurring, but also includes a state close to the state in which surge is occurring or a state leading to surge occurrence. That is, the “surge state” may also be read as “a near-surge state” or “a surge-related state.”

Pressure values from pressure sensors 74a and 74b provided at the inlet and outlet of compressor 22 of turbocharger 20, a turbine rotation number from turbine rotation sensor 75, and a compressor intake air amount from a flow rate sensor (mass flow (MAF) sensor) 76 are input into second determination section 63. Second determination section 63 determines the surge state of the turbocharger based on the pressure difference (or pressure ratio) between the outlet and the inlet of compressor 22 of turbocharger 20, the rotation number of turbine 21, and the amount of intake air sucked by compressor 22.

Control section 61 controls engine 10 and controls assisting engine 10 with electric drive motor 40 based on the determination results of first determination section 62 and second determination section 63. Specifically, when the determination results obtained by first determination section 62 and second determination section 63 indicate that turbocharger 20 is in the vicinity of the surge state, control section 61 performs control such that the rotation speed of engine 10 and the fuel flow rate are suppressed, and engine 10 is assisted by electric drive motor 40. In actuality, vehicle state information such as vehicle speed, vehicle weight, and gear position is also input into control section 61, although not illustrated. Control section 61 takes the vehicle state information into consideration in addition to the determination results of first determination section 62 and second determination section 63 to perform control to suppress the rotation speed of engine 10 and the fuel flow rate.

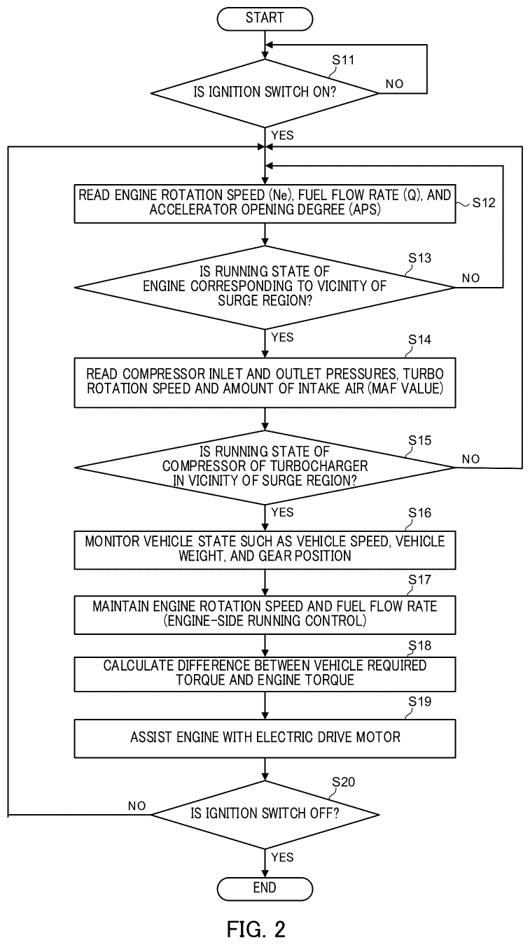

FIG. 2 is a flowchart for describing the operation of hybrid vehicle 1 in the present embodiment.

Hybrid vehicle 1 waits for the ignition switch to be turned ON in step S11, and when the ignition switch is turned ON (step S11; YES), proceeds to step S12.

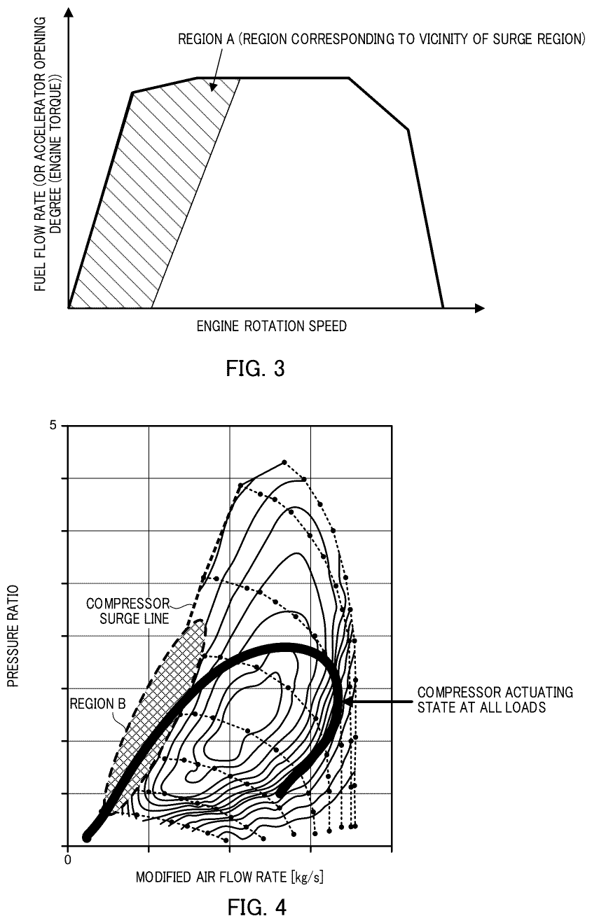

In step S12, first determination section 62 reads the engine rotation speed (Ne), the fuel flow rate (Q), and the accelerator opening degree (APS). In the subsequent step S13, first determination section 62 determines whether the running state of engine 10 is a state corresponding to the vicinity of the surge region of turbocharger 20. Specifically, when the relationship between the engine rotation number and the fuel flow rate (or the accelerator opening degree (may be referred to as the engine torque)) (that is, the actuating point of engine 10) is in region A illustrated with oblique lines in FIG. 3, first determination section 62 determines that the running state of engine 10 is a state corresponding to the vicinity of the surge region of turbocharger 20 (step S13; YES), and proceeds to step S14.

In step S14, second determination section 63 reads a compressor inlet pressure, a compressor outlet pressure, a turbine rotation number, and an amount of intake air (MAF value). In subsequent step S15, second determination section 63 determines whether the running state of compressor 22 of turbocharger 20 is in the vicinity of a surge region. Specifically, the step is as follows: second determination section 63 calculates a modified air flow rate from the turbine rotation number of compressor 22 and the amount of intake air sucked by compressor 22; and when the relationship between the modified air flow rate and the pressure ratio between the compressor inlet pressure and the compressor outlet pressure (that is, the actuating point of compressor 22) is in region B illustrated with the hatching in FIG. 4, second determination section 63 determines that the running state of compressor 22 is a state corresponding to the vicinity of the surge region (step S15; YES), and proceeds to step S16.

In the determination in step S15, the compressor map as illustrated in FIG. 4 is used. However, since this compressor map depends on temperature, it is preferable to prepare a plurality of compressor maps according to temperature and perform the determination in step S15 using a compressor map corresponding to the intake temperature of compressor 22.

In step S16, control section 61 monitors vehicle conditions such as a vehicle speed, a vehicle weight, and a gear position. In step S17, control section 61 controls engine 10 to maintain the engine rotation speed and the fuel flow rate (engine-side running control). That is, control section 61 suppresses the rotation speed of engine 10 and the fuel flow rate.

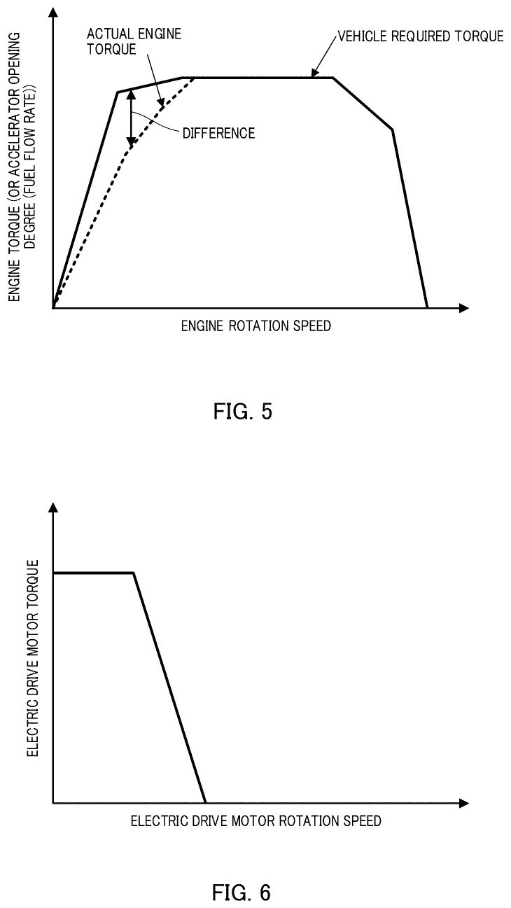

In step S18, control section 61 calculates the difference between a vehicle required torque and an actual engine torque. The vehicle required torque is the torque necessary for vehicle performance, which is calculated by taking into account the vehicle weight and other factors in addition to the accelerator opening degree. The actual engine torque is the engine torque after the rotation speed of engine 10 and the fuel flow rate are suppressed in such a manner that no surging occurs in step S16. Control section 61 calculates the difference between the vehicle required torque and the actual engine torque (the difference is caused by the suppression of the rotation speed of engine 10 and the fuel flow rate to prevent surging in step S16). FIG. 5 illustrates the above situation.

In subsequent step S19, control section 61 performs control to assist engine 10 with electric drive motor 40. Specifically, control section 61 controls electric drive motor 40 to output a torque corresponding to the difference calculated in step S18, thereby supplementing the decrease in the engine torque (which was suppressed to avoid surging) with the output torque of electric drive motor 40. FIG. 6 illustrates an example of the motor rotation speed and the output torque of electric drive motor 40.

In subsequent step S20, hybrid vehicle 1 ends the processing when the ignition switch is determined to be OFF (step S20; YES), and returns the processing to step S12 and repeats the processing described above when the ignition switch is determined not to be OFF (step S20; NO).

As described above, according to the present embodiment, hybrid vehicle 1 includes first determination section 62, which determines a surge state of turbocharger 20 based on a state of engine 10, second determination section 63, which determines a surge state of turbocharger 20 based on a state of turbocharger 20, and control section 61, which controls engine 10 and controls assisting engine 10 with electric drive motor 40 based on determination results of first determination section 62 and second determination section 63.

Thus, it is possible to obtain hybrid vehicle 1 capable of preventing surge from occurring and maintaining drivability, while suppressing an increase in the amount of calculation.

In the embodiment, first determination section 62 performs the determination process for the surge state of engine 10 by using the parameters of engine 10. When first determination section 62 determines that the determination result indicates a state close to surge, second determination section 63 performs the determination process for the surge state of turbocharger 20 by using the parameters of turbocharger 20. In other words, it can be said that after first determination section 62 narrows down the surge state based on a rough determination, second determination section 63 determines the surge state in detail.

Since the determination by second determination section 63 includes a process of calculating the modified air flow rate from the turbine rotation number of compressor 22 and the amount of intake air sucked by compressor 22, the calculation amount becomes very large when all the actuating points in the compressor map as illustrated in FIG. 4 are used as the subjects of processing. In contrast, the determination by first determination section 62 can be easily performed from the relationship between the engine rotation speed and the fuel flow rate (or the accelerator opening degree), and thus, can be achieved with a small amount of calculation.

In the present embodiment, from the viewpoints described above, whether a state is roughly in the vicinity of the surge state is determined by first determination section 62. Then, when first determination section 62 determines that the state is in the vicinity of the surge state, second determination section 63 determines in detail whether the state is in the vicinity of the surge state. In particular, as can be understood from FIG. 4, the actuating point becomes close to a surge line on the low-speed high-load side, and thus, it is necessary to perform precise control in that region. In the present embodiment, first determination section 62 narrows the region where second determination section 63 performs the determination processing down to a region close to the surge line, allowing second determination section 63 to perform precise determinations near the surge line.

Thus, it is possible to determine whether the state is in the vicinity of a surge with certainty and a small amount of calculation. Then, when the state is determined to be in the vicinity of surge by second determination section 63, control section 61 controls electric drive motor 40 to supplement the decrease in engine torque while suppressing engine driving. As a result, it is possible to obtain hybrid vehicle 1 capable of preventing surging and maintaining drivability while suppressing an increase in the amount of calculation.

The above-described embodiment merely describes an example of specific implementation for practicing the present disclosure, and should not be construed as limiting the technical scope of the present disclosure. That is, the present disclosure can be carried out in various forms without departing from the spirit and the main features thereof.

### INDUSTRIAL APPLICABILITY

The present disclosure may be applied to a hybrid vehicle including an engine, a turbocharger, and an electric drive motor.

### REFERENCE SIGNS LIST

1 Hybrid vehicle
10 Engine
20 Turbocharger
21 Turbine
22 Compressor
30 Power transmission mechanism
40 Electric drive motor
60 Control unit
61 Control section
62 First determination section
63 Second determination section
71 Engine rotation sensor
72 Fuel sensor
73 Accelerator sensor
74a, 74b Pressure sensor
75 Turbine rotation sensor
76 Flow rate sensor

1. A hybrid vehicle comprising:
an engine;
a turbocharger connected to an intake/exhaust system of the engine;
an electric drive motor;
a first determination section that performs determination of a surge state of the turbocharger based on a state of the engine;
a second determination section that performs determination of the surge state of the turbocharger based on a state of the turbocharger; and
a control section that controls the engine and controls assisting the engine with the electric drive motor, based on determination results of the first determination section and the second determination section.

2. The hybrid vehicle according to claim 1, wherein
the first determination section performs the determination of the surge state of the turbocharger based on a rotation speed of the engine and a fuel flow rate or an accelerator opening degree.

3. The hybrid vehicle according to claim 1, wherein
the second determination section performs the determination of the surge state of the turbocharger based on pressures at an outlet and an inlet of a compressor of the turbocharger, a rotation number of a turbine, and an amount of intake air sucked by the compressor.

4. The hybrid vehicle according to claim 1, wherein
when the determination results obtained by the first determination section and the second determination section indicate that the turbocharger is in a vicinity of the surge state, the control section suppresses a rotation speed of the engine and a fuel flow rate and causes the electric drive motor to assist the engine.

5. The hybrid vehicle according to claim 4, wherein
the control section calculates a difference between a required torque and an engine torque and controls the electric drive motor to output a torque corresponding to the difference, the engine torque being an engine torque after the rotation speed of the engine and the fuel flow rate are suppressed.

6. The hybrid vehicle according to claim 1, wherein
the determination of the second determination section is performed when the determination result obtained in the first determination section indicates that the turbocharger is in a vicinity of the surge state.

7. A method for controlling a hybrid vehicle that includes an engine, a turbocharger connected to an intake/exhaust system of the engine, and an electric drive motor, the method comprising:
first determining of determining a surge state of the turbocharger based on a state of the engine;
second determining of determining the surge state of the turbocharger based on a state of the turbocharger; and
controlling the engine and controlling assisting the engine with the electric drive motor, based on determination results of the first determining and the second determining.

8. The method according to claim 7, wherein
the second determining is performed when the determination result obtained in the first determining indicates that the turbocharger is in a vicinity of the surge state.
